(19) United States
(12) Patent Application Publication
(10) Pub. No.: US 2006/0026076 A1
(43) Pub. Date: Feb. 2, 2006

(54) Method and apparatus for providing an online ordering system of a retail establishment

(76) Inventor: James M. Raymond, Neptune Beach, FL (US)

Correspondence Address: FOLEY & LARDNER LLP, 150 EAST GILMAN STREET, P.O. BOX 1497, MADISON, WI, 53701-1497, US

(21) Appl. No.: 10/909,644

(22) Filed: Aug. 2, 2004

(51) Int. Cl. G06Q 30/00

(52) U.S. Cl. 705/26

(57) ABSTRACT

A system and method is provided for ordering a product from a retail establishment using a network. The method includes, but is not limited to, sending a first web page to a client device using a network, wherein the first web page is sent from a server and comprises product information of a retail establishment; receiving a product order from the client device at the server using the network, the product order identifying a product selected for purchase from the retail establishment; and sending a purchase request from the server to a credit card authorization terminal of the retail establishment using the network, the purchase request comprising the product order.

### FIELD OF THE INVENTION

The present invention is related to the placement of an order for an item through a network. More particularly, the present invention relates to the placement of product purchase orders with a local retail establishment using the Internet.

### BACKGROUND OF THE INVENTION

The Internet is a wide area network that connects hundreds of thousands of computers and smaller sub-networks world-wide. The World Wide Web (Web) is a subset of the computers that make up the Internet. Businesses, government bodies and entities, educational organizations, and even individuals publish information to the Web thereby making the information accessible to others with access to the Internet. Additionally, e-mail, the oldest Internet application, is used by more and more people as a means to communicate quickly for both personal and business purposes. More recently, instant messaging and chat rooms have evolved to provide real-time communication between individuals through the Internet. These capabilities are now also being provided on mobile communication devices to further connect individuals and businesses.

A website may comprise multiple web pages that display a specific set of information and may contain links to other web pages with related or additional information. Some web pages include multiple web pages that are displayed in combination. Each web page is identified by a Uniform Resource Locator (URL) that includes the location or address of the computer that contains the resource to be accessed, in addition to the location of the resource on that computer. The type of file or resource depends on the Internet application protocol utilized. For example, the HyperText Transfer Protocol (HTTP) describes a web page to be accessed with a web browser application. The file accessed may be a simple text file, an image file, an audio file, a video file, an executable, a common gateway interface application, a Java applet, or any other file type supported by HTTP.

The order and purchase of products using Internet websites is becoming widely accepted by many consumers. The provision of electronic ordering systems reduces labor costs at the retail establishment and provides more consistent customer service. However, use of the Internet for the purchase of products from local retail establishments, particularly restaurants, flower shops, and other local businesses that provide for the delivery or for the pick-up of products, has not seen widespread acceptance partly due to the expense incurred by the retail establishment in developing and maintaining a website and in purchasing the additional equipment needed to process the product purchase requests at the retail establishment. A variety of solutions have been proposed to provide for the electronic ordering of local products for pick-up or for delivery, but none have been widely accepted largely due to the expense on the part of the retail establishment and to inconvenience for the consumer. Thus, there is a need for a method and a system for conveniently and for cost effectively providing for the ordering of a product from a retail establishment using a network. Further, there is a need for an online ordering system and method that does not require any additional equipment at the retail establishment for processing product purchase requests from the network.

### SUMMARY OF THE INVENTION

An exemplary embodiment of the invention relates to a method for ordering a product from a retail establishment using a network. The method includes, but is not limited to, sending a first web page to a client device using a network, wherein the first web page is sent from a server and comprises product information of a retail establishment; receiving a product order from the client device using the network, the product order identifying a product selected for purchase from the retail establishment; and sending a purchase request to a credit card authorization terminal of the retail establishment using the network, the purchase request comprising the product order. Using the network comprises using messaging protocols. The purchase request may include, but is not limited to, an instant message, an e-mail message, a short message, a multimedia message, a Hypertext Markup Language message, and a conversational hypertext access technology message.

The method may further include, before sending the first web page to the client device, sending a second web page to the client device, wherein the second web page is received from the server and comprises a plurality of retail establishments and receiving a retail establishment identifier from the client device at the server using the network, the retail establishment identifier identifying the retail establishment selected from the plurality of retail establishments.

The method may further include searching a database for messaging information of the credit card authorization terminal at the server, selecting the messaging information of the credit card authorization terminal at the server, and using the messaging information to send the purchase request from the server to the credit card authorization terminal.

Sending the purchase request from the server to the credit card authorization terminal may include, but is not limited to, sending the purchase request from the server to a message server and sending the purchase request from the message server to the credit card authorization terminal. The method may further include searching a database for messaging information of the credit card authorization terminal at the message server, selecting the messaging information of the credit card authorization terminal at the message server, and using the messaging information to send the purchase request from the message server to the credit card authorization terminal.

The method may further include sending a request for contact information from the server to the client device using the network before sending the purchase request. The contact information may include, but is not limited to, an instant message address, an e-mail address, a short message address, a multimedia message address, a conversational hypertext access technology address, a telephone number, and a street address.

The method may further include receiving electronic payment information from the client device at the server using the network and sending the electronic payment information from the server to the credit card authorization terminal of the retail establishment using the network.

The method may further include receiving an order processing time from the client device at the server using the network, wherein sending the purchase request from the server to the credit card authorization terminal occurs when a current time is greater than or equal to the order processing time.

An exemplary embodiment of the invention relates to a method of processing a product order at a retail establishment using a network. The method includes, but is not limited to, receiving a purchase request from a server at a credit card authorization terminal using a network, the purchase request comprising a product order received from a client device and presenting the purchase request at the credit card authorization terminal. The response may include, but is not limited to, an instant message, an e-mail message, a short message, a multimedia message, a Hypertext Markup Language message, and a conversational hypertext access technology message. Presenting the purchase request at the credit card authorization terminal may include, but is not limited to, printing the purchase request at the credit card authorization terminal.

The method may further include providing a plurality of responses to the purchase request at the credit card authorization terminal and sending a response selected from the plurality of responses from the credit card authorization terminal to the client device. Sending the response selected from the plurality of responses from the credit card authorization terminal to the client device may include, but is not limited to, sending the response from the credit card authorization terminal to the server and sending the response from the server to the client device. As another alternative, sending the response selected from the plurality of responses from the credit card authorization terminal to the client device may include, but is not limited to, sending the response from the credit card authorization terminal to a message server, sending the response from the message server to the server, and sending the response from the server to the client device.

The method may further include receiving electronic payment information from the server at the credit card authorization terminal using the network and processing the electronic payment information at the credit card authorization terminal.

Another exemplary embodiment of the invention relates to a computer program product for allowing a user to place an order for a product from a retail establishment using a network. The computer program product includes, but is not limited to, computer code configured to send a first web page to a client device using a network, wherein the first web page comprises product information of a retail establishment for display at the client device; to receive a product order from the client device using the network, the product order identifying a product selected for purchase from the retail establishment; and to send a purchase request to a credit card authorization terminal of the retail establishment using the network, the purchase request displayed at the credit card authorization terminal and comprising the product order.

Still another exemplary embodiment of the invention relates to a server that provides a user with the capability to place an order for a product from a retail establishment using a network. The server includes, but is not limited to, a communication interface, a server application, a memory, and a processor. The communication interface is capable of communicating with a network and is configured to send a first web page to a client device, to receive a product order from the client device, and to send a purchase request to a credit card authorization terminal of the retail establishment. The server application includes, but is not limited to, computer code configured to select the first web page sent to the client device, wherein the first web page comprises product information of a retail establishment selected for display at the client device; to process the product order received from the client device, the product order identifying a product selected for purchase from the retail establishment; and to prepare the purchase request sent to the credit card authorization terminal, the purchase request displayed at the credit card authorization terminal and comprising the product order. The memory is configured to store the server application. The processor is coupled to the memory and is configured to execute the server application.

Still another exemplary embodiment of the invention relates to a system for providing a user with the capability to place an order for a product from a retail establishment using a network. The system includes, but is not limited to, a client device, a server, a credit card authorization terminal, and a network configured to allow communication between the client device, the server, and the credit card authorization terminal. The client device includes but is not limited to, a client device communication interface, a communication application, a client device memory, and a client device processor. The client device communication interface is capable of communicating with a network and is configured to receive a first web page from the server and to send a product order to the server. The communication application includes, but is not limited to, computer code configured to display the first web page, wherein the first web page comprises product information of a retail establishment selected for display, and to accept the product order, the product order identifying a product selected for purchase from the retail establishment. The client device memory is configured to store the communication application. The client device processor is coupled to the client device memory and is configured to execute the communication application.

The server includes, but is not limited to, a server communication interface, a server application, a server memory, and a server processor. The server communication interface is capable of communicating with the network and is configured to send the first web page to the client device, to receive the product order from the client device, and to send a purchase request to a credit card authorization terminal of the retail establishment. The server application includes, but is not limited to, computer code configured to select the first web page sent to the client device, to process the product order received from the client device, and to prepare the purchase request sent to the credit card authorization terminal, the purchase request comprising the product order. The server memory is configured to store the server application. The server processor is coupled to the server memory and is configured to execute the server application.

The credit card authorization terminal includes, but is not limited to, a terminal communication interface, a terminal application, a terminal memory, and a terminal processor. The terminal communication interface is capable of communicating with the network and is configured to receive the purchase request. The terminal application includes, but is not limited to, computer code configured to display the purchase request. The terminal memory is configured to store the terminal application. The terminal processor is coupled to the terminal memory and is configured to execute the terminal application.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of the architecture of a product ordering system in accordance with an exemplary embodiment.

FIG. 2 is an overview diagram of example system components of the product ordering system of FIG. 1.

FIG. 3 is a component diagram of an example client device of the product ordering system of FIG. 1.

FIG. 4 is a component diagram of an example credit card authorization terminal of the product ordering system of FIG. 1.

FIG. 5 is a component diagram of an example server of the product ordering system of FIG. 1.

FIG. 6 is a functional diagram of an example server of the product ordering system of FIG. 1.

FIG. 7 is a functional flow diagram of processing at the example client device system component of FIG. 3.

FIG. 8 is a functional flow diagram of processing at the example server system component of FIG. 5.

FIG. 9 is a functional flow diagram of processing at the example credit card authorization system component of FIG. 4.

### DETAILED DESCRIPTION OF THE PREFERRED EMBODIMENTS

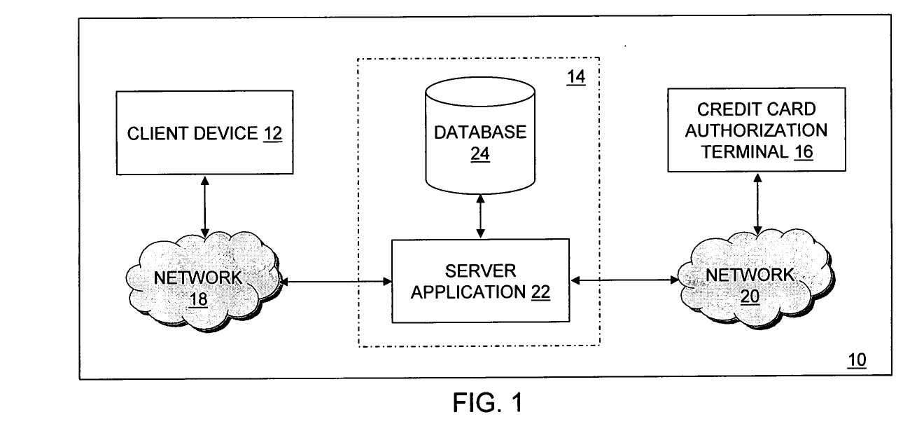

With reference to FIG. 1, a product ordering system 10 is comprised of a client device 12, a server 14, and a Credit Card Authorization Terminal (CCAT) 16. The client device 12 interacts with the server 14 using a network 18. The network 18 may include, but is not limited to the Internet, and provides for the transmission of information between the client device 12 and the server 14. The server 14 interacts with the CCAT 16 using a network 20. The network 20 may include, but is not limited to the Internet, and provides for the transmission of information between the server 14 and the CCAT 16. The network 18 and the network 20 may comprise the same or different networks. The server device 14 includes, but is not limited to, a server application 22 and a database 24 that stores data accessible by the server application 22. The server application 22 may comprise multiple modules. The modules may be located on different devices that are connected to one or more networks such as a cellular telephone network, a wireless Local Area Network (LAN), a Bluetooth Personal Area Network (PAN), an Ethernet LAN, a token ring LAN, a Wide Area Network (WAN), the Internet, etc.

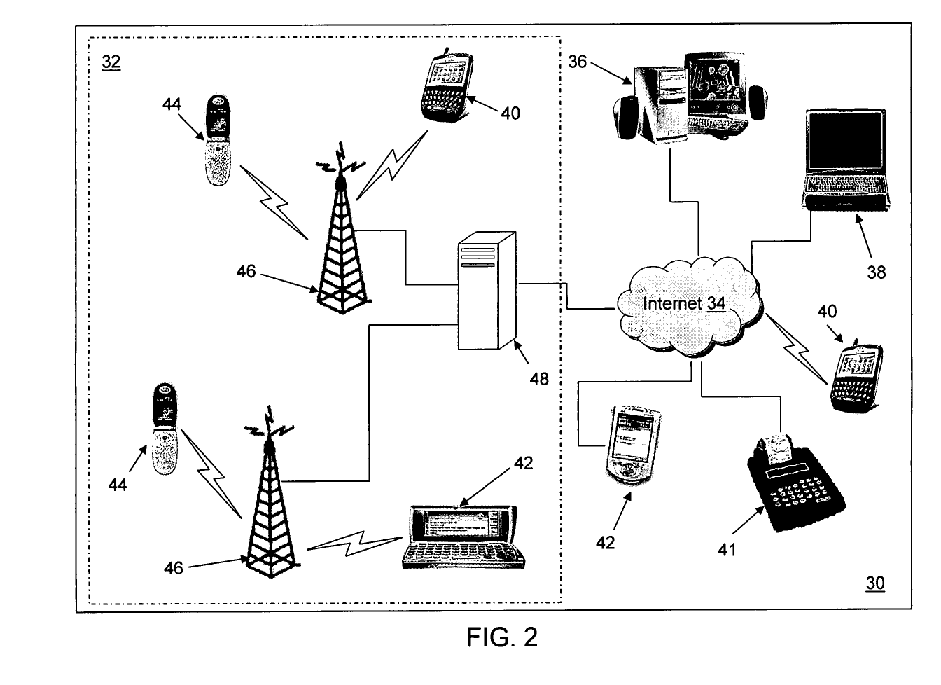

With reference to FIG. 2, the system 30 is comprised of multiple devices that can communicate through one or more networks. The system 30 may comprise any combination of wired or wireless networks including, but not limited to, a cellular telephone network 32, a wireless LAN, a Bluetooth PAN, an Ethernet LAN, a token ring LAN, a WAN, the Internet 34, etc. The system 30 may include both wired and wireless devices. For exemplification, the system 30 shown in FIG. 2 includes the cellular telephone network 32 and the Internet 34. Connectivity to the Internet 34 may include, but is not limited to, long range wireless connections, short range wireless connections, and various wired connections including, but not limited to, telephone lines, cable lines, power lines, etc.

The cellular telephone network 32 includes, but is not limited to, one or more devices, a base station 46, and a network server 48. In the cellular telephone network 32, the devices may send and receive signals through the base station 46. The network server 48 allows communication between the devices and another network. For example, the network server 48 may connect the devices with other devices through the Internet 34. The devices may include, but are not limited to, computers of all form factors such as a desktop computer 36, a notebook computer 38, an Instant Messaging Device (IMD) 40, such as those manufactured by Blackberry, Inc., a credit card authorization device 41, a Personal Data Assistant (PDA) 42, such as those manufactured by PALM, Inc., and/or a cellular telephone 44. The system 30 may include additional devices and devices of different types as well as any combination of devices. The functionalities described for the client device 12, the server 14, and the CCAT 16 may be implemented in any of the devices.

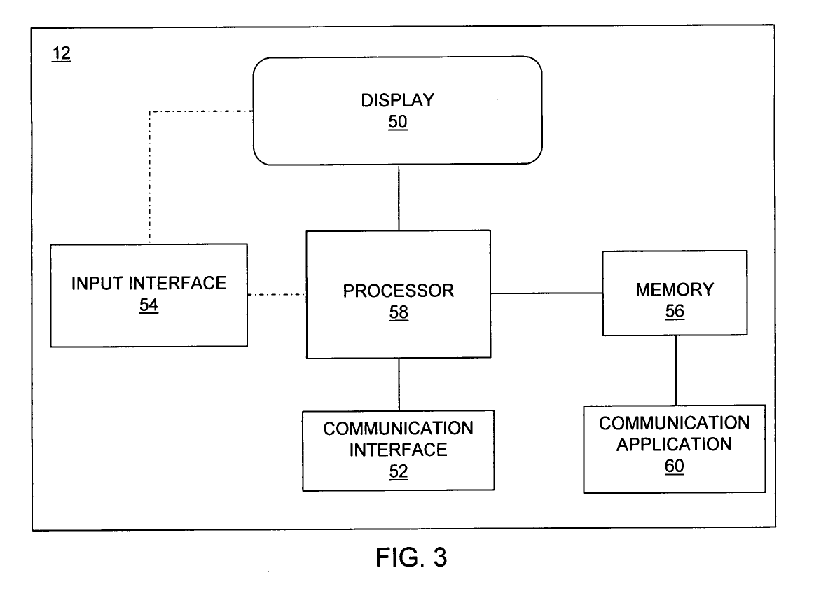

For exemplification, FIG. 3 shows a component block diagram of the client device 12 that may be included in system 30 in an exemplary embodiment. The client device 12 includes a display 50, a communication interface 52, an input interface 54, a memory 56, a processor 58, and a communication application 60. The components of the client device 12 may be embodied in a device understood to include, without limitation, the cellular telephone 44, the PDA 42, the IMD 40, the credit card authorization device 41, computers of all form factors, etc. The client device 12 may or may not be mobile. Different and additional components may be incorporated into the client device 12. The client device 12 allows a user to connect to a network, such as the cellular telephone network 32, a wireless LAN, a Bluetooth PAN, an Ethernet LAN, a token ring LAN, a WAN, the Internet 34, a land based telephone network, etc., and to send and to receive communications from other devices connected to the network. The components of client device 12 may each be internal or external to the client device 12. The components may connect to each other using a number of different methods as known to those skilled in the art. Connections between the components of client device 12 may be other than or in addition to those shown in FIG. 3.

The display 50 presents information to the user of the client device 12 including, but not limited to, information from the communication application 60. The display may be, but is not limited to, a thin film transistor (TFT) display, a light emitting diode (LED) display, a Liquid Crystal Display (LCD), a Cathode Ray Tube (CRT) display, etc.

The communication interface 52 provides an interface for receiving and transmitting calls, messages, and/or any other information communicated across the network including, but not limited to, a HyperText Markup Language (HTML) web page and the communication of message types that include an instant message, an e-mail message, a short message, a multimedia message, and a Conversational Hypertext Access Technology (CHAT) message. The communication interface 52 may provide communication with one or more networks. The client device 12 may include one or more communication interfaces 52. Communications between the client device 12 and the network may be through one or more of the following connection methods, without limitation: an infrared communications link, a wireless communications link, a cellular network link, a physical serial connection, a physical parallel connection, a link established according to the Transmission Control Protocol/Internet Protocol (TCP/IP) and Standards, a telephone line, etc.

To access information or to communicate with people using the Internet or another network generally requires use of a variety of different messaging protocols. Protocols commonly used include, but are not limited to, HTTP, the File Transfer Protocol (FTP), the Post Office Protocol (POP), the Simple Mail Transfer Protocol (SMTP), the Internet Message Access Protocol (IMAP), the Session Initiation Protocol (SIP), the Message Session Relay Protocol (MSRP), the Real Time Transport Protocol (RTTP), the Session Description Protocol (SDP), TCP/IP, SIP for Instant Messaging and Presence Leveraging Extensions (SIMPLE), the extensible Messaging and Presence Protocol (XMPP), etc. For example, the Web consists of web servers that respond to HTTP requests to access a web page. Each web page is identified by a URL that includes the location or web address of the computer that contains the resource to be accessed in addition to the location of the resource on that computer.

An Internet or Web address, generally is composed of four parts: a protocol name, the location of a web server that provides the website information, a name identifying the organization or individual that maintains the web server, and a suffix that identifies the type of organization. For example, “.com” identifies a commercial organization, “.edu” identifies an educational institution, and “.gov” identifies a government organization. The protocol name specifies the protocol (i.e. HTTP, POP3, SMTP, FTP, SIP, SIMPLE) that defines the set of rules and standards to be applied when exchanging information between the server that communicates the information and a client device that receives and displays the information. The URL includes the Internet address and the resource location at the server. The resource defines the information presentation format.

Communications between the client device 12 and the network may use one or more messaging protocol without limitation. Transferring content to and from the client device 12 may use one or more connection method and messaging protocol or any others known to those skilled in the art or to be developed in the future.

The input interface 54 provides an interface for receiving information from the user for entry into the client device 12. The input interface 54 may use various input technologies including, but not limited to, a keyboard, a pen and touch screen, a mouse, a track ball, a touch screen, a keypad, one or more buttons, etc. to allow the user to enter information into the client device 12 or to make selections from the client device 12. The input interface 54 may provide both an input and an output interface. For example, a touch screen display allows the user to make selections and presents information to the user.

The memory 56 provides an electronic holding place for an operating system of the client device 12, the communication application 60, and/or other applications. The client device 12 may have a plurality of memory devices 56 that use the same or different memory technologies. Example memory technologies include, but are not limited to, Random Access Memory (RAM), Read Only Memory (ROM), flash memory, etc. Data in RAM is volatile meaning that it remains only as long as the client device 12 is turned on. When the client device 12 is turned off, RAM loses its data. The values stored in ROM are always there, whether the client device 12 is on or not. For this reason, it is called non-volatile memory. Flash memory is a type of constantly-powered non-volatile memory that can be erased and reprogrammed in units of memory called blocks. A variety of different storage media may be used for each memory technology. For example, a Compact Disk (CD), a Digital Video Disk (DVD), and a hard disk are all ROM media types.

The processor 58 executes instructions that cause the client device 12 to perform various functions. The instructions may be written using one or more programming languages, scripting languages, assembly languages, etc. Additionally, the instructions may be carried out by a special purpose computer, logic circuits, or hardware circuits. Thus, the processor 58 may be implemented in hardware, firmware, software, or any combination of these methods. The term “execution” refers to the process of running an application or program or the carrying out of the operation called for by an instruction. The processor 58 executes an application meaning that it performs the operations called for by that application in the form of a series of instructions. The processor 58 may retrieve an application from a non-volatile memory that is generally some form of ROM or flash memory and may copy the instructions in an executable form to a temporary memory that is generally some form of RAM. The processor 58, for example, may execute instructions embodied in the operating system of the client device 12 and the communication application 60. The client device 12 may include one or more processor 58.

The communication application 60 is an organized set of instructions that, when executed, cause the client device 12 to perform certain functions. The communication application 60 may be written using one or more programming languages, assembly languages, scripting languages, etc. For the communication application 60 to execute, the application may be translated into a machine language that the processor 58 understands. The machine language version of the communication application 60 generally is known as the executable and is the commercially available version of the communication application 60. The user executes the communication application 60 by selecting the communication application 60 for launch. The communication application 60 may communicate with one or more servers. For example, the servers may be mail servers, web servers, etc. The communication application 60 may respond to various protocol commands, may interpret HTML and other Internet programming languages including, but not limited to, Java™, Perl, and the extensible Markup Language (XML), and may present a web page for viewing by the user. The communication application 60 may display or otherwise process messages. The communication application 60 may be a web browser, an e-mail application, an IM application, etc. as known to those skilled in the art.

The communication application 60 may respond to any of the following messaging protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. The communication application 60 may receive and may display one or more web pages sent to the client device 12 based on the user selection at the client device 12. The client device 12 may include one or more communication application 60. For example, an IM application, an e-mail application, and/or a browser may be provided.

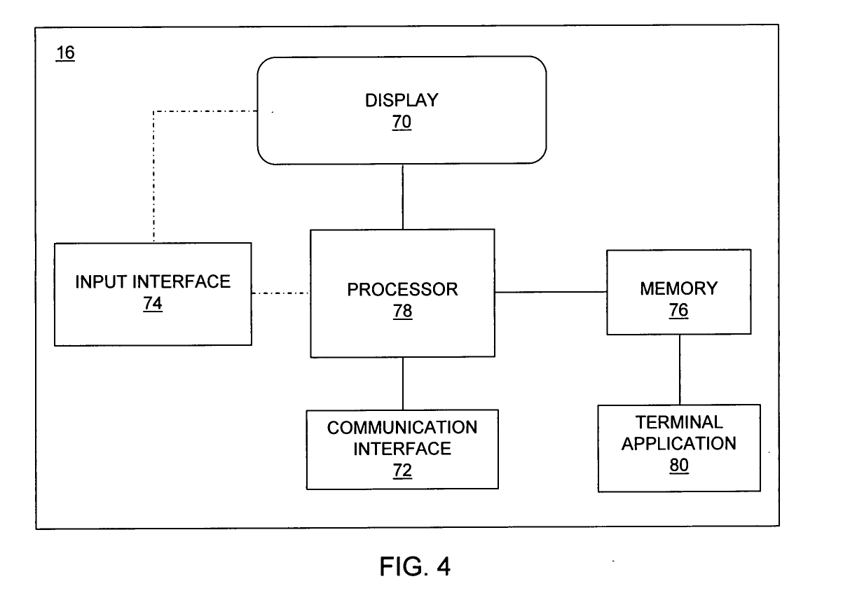

For exemplification, FIG. 4 shows a component block diagram of the CCAT 16 that may be included in system 30 in an exemplary embodiment. The CCAT 16 includes, but is not limited to, a display 70, a communication interface 72, an input interface 74, a memory 76, a processor 78, and a terminal application 80. The components of the CCAT 16 may be embodied in a device understood to include, without limitation, the cellular telephone 44, the PDA 42, the IMD 40, the credit card authorization device 41, computers of all form factors, etc. The CCAT 16 may or may not be mobile. Different and additional components may be incorporated into the CCAT 16. The CCAT 16 allows a user to connect to a network, such as the cellular telephone network 32, a wireless LAN, a Bluetooth PAN, an Ethernet LAN, a token ring LAN, a WAN, the Internet 34, a land based telephone network, etc., and to send and to receive communications from other devices connected to the network. The components of CCAT 16 may each be internal or external to the CCAT 16. The components may connect to each other using a number of different methods as known to those skilled in the art. Connections between the components of CCAT 16 may be other than or in addition to those shown in FIG. 4.

The display 70 presents information to the user of the CCAT 16 including, but not limited to, information from the terminal application 80. The display may be, but is not limited to, a TFT display, an LED display, an LCD, a CRT display, a thermal printer, an inkjet printer, a laser printer, etc.

The communication interface 72 provides an interface for receiving and transmitting calls, messages, and/or any other information communicated across the network including, but not limited to, the communication of message types including an instant message, an e-mail message, a short message, a multimedia message, and a CHAT message. The communication interface 72 may provide communication with one or more networks. The CCAT 16 may include one or more communication interface 72. Communications between the CCAT 16 and the network may be through one or more of the following connection methods, without limitation: an infrared communications link, a wireless communications link, a cellular network link, a physical serial connection, a physical parallel connection, a link established according to the TCP/IP Standards, a telephone line, etc. Communications between the CCAT 16 and the network may use one or more of the following messaging protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. Transferring content to and from the CCAT 16 may use one or more connection method and messaging protocol or any others known to those skilled in the art or to be developed in the future.

The input interface 74 provides an interface for receiving information from the user for entry into the CCAT 16. The input interface 74 may use various input technologies including, but not limited to, a keyboard, a pen and touch screen, a mouse, a track ball, a touch screen, a keypad, one or more buttons, etc. to allow the user to enter information into the CCAT 16 or to make selections from the CCAT 16. The input interface 74 may provide both an input and an output interface. For example, a touch screen display allows the user to make selections and presents information to the user.

The memory 76 provides an electronic holding place for an operating system of the CCAT 16, the terminal application 80, and/or other applications. The CCAT 16 may have one or more memory device 76 that use the same or different memory technologies. Example memory technologies include, but are not limited to, RAM, ROM, flash memory, etc.

The processor 78 executes instructions that cause the CCAT 16 to perform various functions. The instructions may be written using one or more programming languages, scripting languages, assembly languages, etc. Additionally, the instructions may be carried out by a special purpose computer, logic circuits, or hardware circuits. Thus, the processor 78 may be implemented in hardware, firmware, software, or any combination of these methods. The processor 78 executes an application meaning that it performs the operations called for by that application in the form of a series of instructions. The processor 78 may retrieve an application from a non-volatile memory that is generally some form of ROM or flash memory and may copy the instructions in an executable form to a temporary memory that is generally some form of RAM. The processor 78, for example, may execute instructions embodied in the operating system of the CCAT 16 and the terminal application 80. The CCAT 16 may include one or more processors 78. The operating system of the CCAT 16 may provide a secure multi-application environment. For example, the CCAT 16 may include an electronic payment processing application that processor 78 executes simultaneously with the terminal application 80.

The terminal application 80 is an organized set of instructions that, when executed, cause the CCAT 16 to perform certain functions. The terminal application 80 may be written using one or more programming languages, assembly languages, scripting languages, etc. For the terminal application 80 to execute, the application may be translated into a machine language that the processor 78 understands. The machine language version of the terminal application 80 generally is known as the executable and is the commercially available version of the terminal application 80. The user may execute the terminal application 80 by selecting the terminal application 80 for launch. Alternatively, the terminal application 80 may execute in the background or may execute when a message to be processed by the terminal application 80 is received through the communication interface 72. The terminal application 80 may communicate with one or more servers. The terminal application 80 may respond to various protocol commands received through the communication interface 72, may interpret HTML and other programming languages including, but not limited to, Java™, Perl, and XML, may display or otherwise process messages using the display 70, and may respond to user input through the input interface 74.

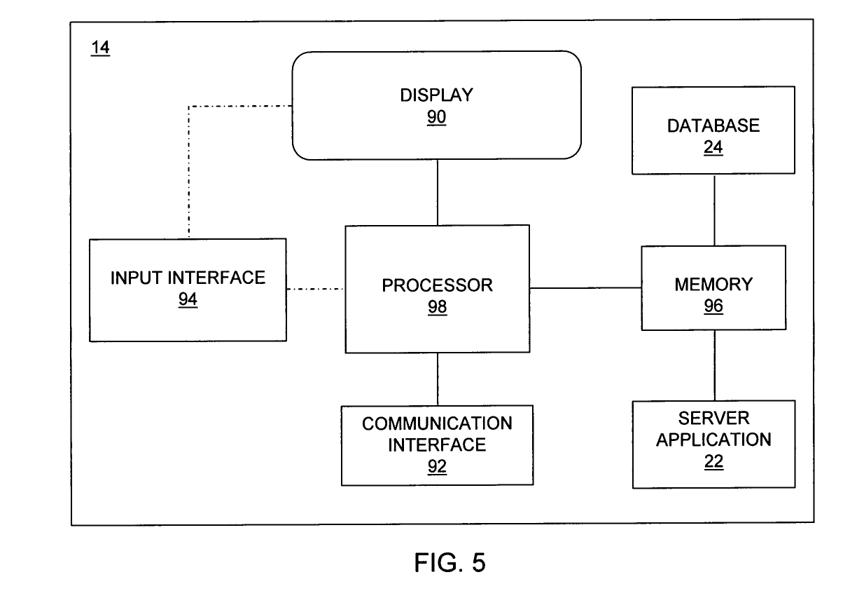

For exemplification, FIG. 5 shows a component diagram of server 14 that includes, but is not limited to, a display 90, a communication interface 92, an input interface 94, a memory 96, a processor 98, the server application 22, and the database 24. The components of the server 14 may be embodied in a device understood to include, without limitation, computers of all form factors. The modules of server 14 may be embodied in multiple devices communicably connected. Different and additional components may be incorporated into the server 14. The server 14 communicates website information to the client device 12 and communicates product order information to the CCAT 16. The components of server 14 may each be internal or external to the server 14. The components may connect using a number of different methods as known to those skilled in the art. Connections may be other than or in addition to those shown in FIG. 5.

The display 90 presents information to the user of the server 14 including, but not limited to, information from the server application 22. The display may be, but is not limited to, a TFT display, an LED display, an LCD display, a CRT display, etc. The display 90 is optional.

The communication interface 92 provides an interface for receiving and transmitting calls, messages, and/or any other information communicated across a network including messages of all types. The communication interface 92 may provide communication with one or more networks. The server 14 may include one or more communication interfaces 92. Communications between the server 14 and the network may be through one or more of the following connection methods, without limitation: an infrared communications link, a wireless communications link, a cellular network link, a physical serial connection, a physical parallel connection, a link established according to the TCP/IP Standards, a telephone line, etc. Communications between the server 14 and the network may use one or more of the following messaging protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. Transferring content to and from the server 14 may use one or more connection method and messaging protocol or any others known to those skilled in the art or to be developed in the future.

The input interface 94 may provide an interface for receiving information from the user for entry into the server 14. The input interface 94 may use various input technologies including, but not limited to, a keyboard, a pen and touch screen, a mouse, a track ball, a touch screen, a keypad, one or more buttons, etc. to allow the user to enter information into the server 14 or to make selections from the server 14. The input interface 94 may provide both an input and an output interface. For example, a touch screen display allows the user to make selections and presents information to the user. The input interface 94 is optional.

The memory 96 provides an electronic holding place for an operating system of the server 14, the server application 22, the database 24, and/or other applications so that the information can be reached quickly by the processor 98. The server 14 may have one or more memory device 96 that may use different memory technologies including, but not limited to, RAM, ROM, flash memory, etc. The server 14 may access the memory 96 using a network.

The processor 98 executes instructions that cause the server 14 to perform various functions. The instructions may be written using one or more programming languages, scripting languages, assembly languages, etc. Additionally, the instructions may be carried out by a special purpose computer, logic circuits, or hardware circuits. Thus, the processor 98 may be implemented in hardware, firmware, software, or any combination of these methods. The processor 98 executes an application meaning that it performs the operations called for by that application in the form of a series of instructions. The processor 98 may retrieve an application from a non-volatile memory that is generally some form of ROM or flash memory and may copy the instructions in an executable form to a temporary memory that is generally some form of RAM. The processor 98 may execute instructions embodied in the server application 22. The server 14 may include one or more processor 98.

The server application 22 may communicate with the communication application 60 at the client device 12 and/or the terminal application 80 at the CCAT 16. The server application 22 may respond to any of the following messaging protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. The server application 22 may respond to various protocol commands, may interpret HTML and other Internet programming languages including, but not limited to, Java™, Perl, and XML. The server application 22 may display or otherwise process messages. The server application 22 may transmit one or more web pages to the client device 12 based on the user selection at the client device 12 and/or the processing of the communication application 60.

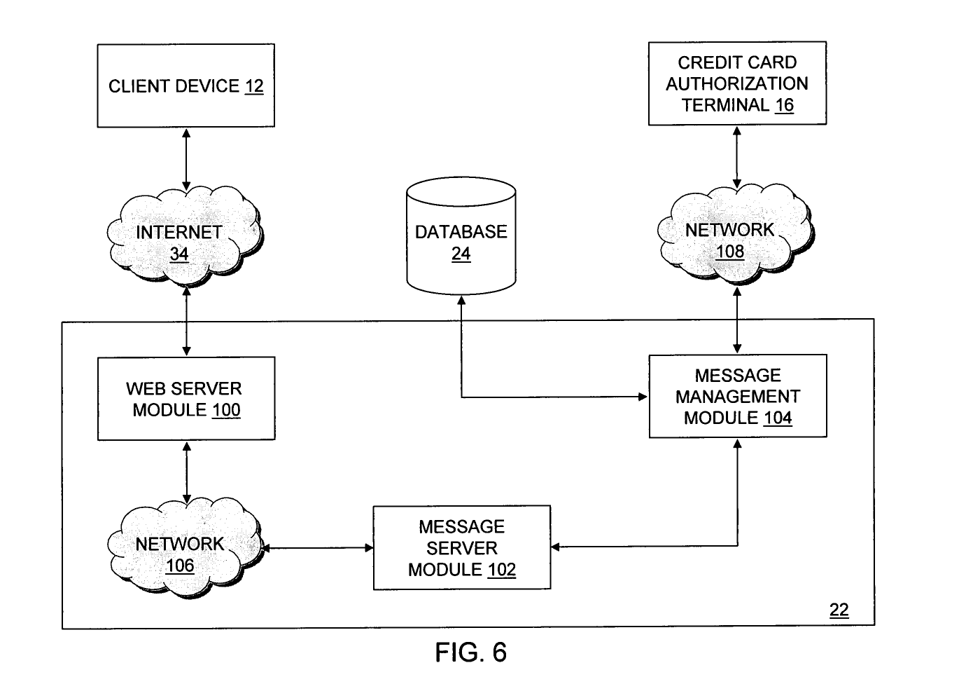

In the exemplary embodiment of FIG. 6, the functional processing of the server application 22 includes, but is not limited to, a web server module 100, a message server module 102, and a message management module (MMM) 104. The Internet 34 may provide the network for communicating information between the client device 12 and the server 14. Information flow between the client device 12 and the server 14 may be encrypted to maintain data security. A network 108 may provide the network for communicating information between the server 14 and the CCAT 16. The network 108 may be, for example, a LAN, a WAN, and/or the Internet 34. Information flow between the server 14 and the CCAT 16 may be encrypted to maintain data security.

The server application 22 modules may be executed from a single device. Alternatively, the server application 22 modules may be executed from multiple devices in communication. For example, the web server module 100 executing at a first device may communicate with the message server module 102 executing at a second device using a network 106. The network 106 may include, without limitation, a wireless LAN, a Bluetooth PAN, an Ethernet LAN, a token ring LAN, a WAN, the Internet 34, etc.

The web server module 100 processes information exchanged between the client device 12 and the server application 22 and may communicate with the communication application 60. The web server module 100 provides website information to the client device 12 that receives and displays the website information. The URL entered in the communication application 60 at the client device 12 includes the IP address of the server 14 that provides the web server module 100 and the resource location at the server 14. The resource defines the web page presentation. The web server module 100 may respond to HTTP commands and may transmit one or more web pages to the client device 12 based on the user selection at the client device 12.

The message server module 102 sends and receives messages and may act as the interface between the web server module 100 and the MMM 104. Messaging technologies include e-mail, Instant Messaging (IM), short messaging, multimedia messaging, and CHAT. Short messaging and multimedia messaging are hybrids of e-mail and IM. The Short Messaging Service (SMS) is a store and forward method of transmitting short messages to and from devices. SMS can also be used to transmit e-mail and IM messages. The Multimedia Messaging Service (MMS) transmits messages to and from devices in a store-and-forward manner much like SMS, but MMS allows a combination of text, sounds, images, and video. Chat rooms generally located on the Internet provide real-time, broadcast text messaging between a group of individuals who have joined the room.

Although e-mail, SMS, and MMS are store and forward systems that utilize a gateway to pass messages from senders to recipients, there are differences between these text messaging technologies. The most obvious difference is the length and the complexity of the messages. E-mail allows the attachment of files, the imbedding of images, and allows the use of HTML. SMS messages are limited to text messages generally between 80 and 500 characters depending on the service provider. MMS messages allow sounds, images, and video in addition to text displays. Additionally, messages generated by SMS and by MMS are immediately delivered directly to the device; whereas, e-mail may not be immediately delivered directly to the device, but may be stored in mail servers and sent either periodically or when a user logs onto the e-mail system. By comparison, an Instant Messaging Service (IMS) provides a user with access to a virtually real-time text conversation (or chat) with others who are simultaneously connected to the Internet.

E-mail systems generally use the Internet to transmit communications. E-mail transmission, delivery, and processing employs a variety of protocols with SMTP, POP3, and IMAP being the most widely used. SMTP transfers e-mail between devices and is used to send e-mail. A mail server receives the e-mail and handles it on behalf of the recipient. The e-mail is then read generally using either POP3 or IMAP. Using POP3, the e-mail is stored on the mail server until the recipient connects to the server when the e-mail is downloaded to the recipient's computer and removed from the mail server computer. Using IMAP, the e-mail is saved at the mail server. When the recipient connects to the mail server, the recipient views the e-mail sender and header. The recipient may then choose to download the e-mail or not. A mail server is an example message server module 102 that uses underlying messaging protocols to send and to receive e-mail messages and to present the communication information to the user in an easily understandable form. E-mail messages may include SMS messages and MMS messages.

An e-mail address is a URL. The e-mail URL includes the protocol, the mailbox, and the hostname of the computer that generally hosts the mail server. The mailbox and hostname are separated by an @ sign in the form “johndoe@acme.com” wherein “johndoe” is the mailbox name and “acme.com” identifies the hostname of the mail server.

An IM application is another example message server module 102 that uses underlying protocols to send and to receive IM messages and to present the communication information to the user in an easily understandable form. IM applications provide message and presence exchange in real time between two points on the Internet. IM systems generally provide one-to-one messaging, multi-user messaging, the ability to subscribe to a contact's presence, etc. An IM contact is a URL that may use any of a number of messaging protocols including, but not limited to, SIP, SIMPLE, XMPP, MSRP, RTP, etc. and identifies an individual in a manner similar to an e-mail address.

The MMM 104 provides the interface between the server 14 and the CCAT 16. The MMM may receive messages from the message server module 102 and send messages to the message server module 102. The MMM may receive messages from the CCAT 16 and send messages to the CCAT 16. The MMM 104 may access the database 24 to retrieve information related to the transmission of messages between the server 14 and the CCAT 16. The database 24 may utilize various database technologies as known to those skilled in the art including a simple file system and/or a system of tables. The database 24 also may use a variety of different formats as known to those skilled in the art. The server 14 may include a plurality of databases 24. Any of the modules of the server 14 may access the database 24 possibly through the network 106.

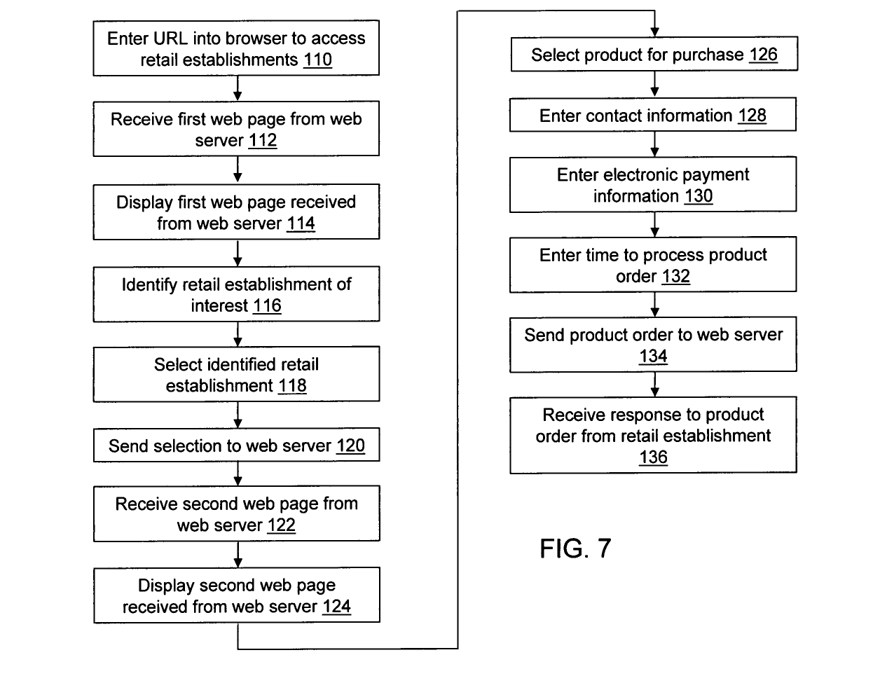

With reference to the exemplary embodiment of FIG. 7, the operations of the client device 12 will be described below. FIG. 7 shows a functional flow diagram of processing operations performed at the client device 12. Additional, fewer, or different operations may be performed, depending on the embodiment without deviating from the spirit of the invention. At operation 110, the user of the client device 12 enters a URL into the communication application 60 to access a website that includes a plurality of retail establishments. The communication application 60 may comprise a browser application. Instead of entering the URL to access the website, the user may select a hyperlink selectable from a webpage using the communication application 60. At operation 112, the communication application 60 at the client device 12 receives a first web page that corresponds to the entered or the selected URL from the web server module 100 of the server 14. At operation 114, the communication application 60 displays the first web page to the user.

At operation 116, the user identifies a retail establishment of interest to the user. For example, the user may identify the retail establishment based on the location of the retail establishment, the type of product sold by the retail establishment, the price of the products sold, etc. The user, at operation 118, selects the identified retail establishment, for example, by selecting a hyperlink to the retail establishment website. The communication application 60 sends the selection to the web server module 100 at operation 120. The selection includes an identifier of the retail establishment selected that may be, but is not limited to, the hyperlink, a code, a retail establishment name, a retail establishment address, a retail establishment phone number, etc. At operation 122, the communication application 60 at the client device 12 receives a second web page that corresponds to the entered or the selected retail establishment from the web server module 100 of the server 14. At operation 124, the communication application 60 displays the second web page to the user. The second web page includes product information of the selected retail establishment. The product information may include, but is not limited to, a price, a product description, a product picture, a menu, etc.

At operation 126, the user may select a product for purchase from the second web page. Alternatively, the user may browse the retail establishment website to view additional web pages containing items for purchase as known to those skilled in the art. The user may select one or more products from the retail establishment website for purchase. For example, the web page of the retail establishment may contain a menu that includes food items for purchase. The user may select multiple food items for purchase. At operation 128, the user may enter contact information to allow the retail establishment to contact the user concerning the product purchase. The contact information may include, but is not limited to, an instant message address, an e-mail address, a short message address, a multimedia message address, a CHAT address, a telephone number, and/or a street address.

At operation 130, the user may enter electronic payment information to allow the CCAT 16 to charge the user for the product purchase. Alternatively, the server 14 may use the entered electronic payment information to charge the user for the product purchase. The electronic payment information, for example, may include a credit card number, a credit card expiration date, a billing address, etc. as known to those skilled in the art. At operation 132, the user may enter a time to process the product order with the retail establishment. The time may be entered through the web page using a number of different methodologies as known to those skilled in the art. For example, a user may select from a drop down box that includes times during which the retail establishment may process the order.

At operation 134, the product order information is sent to the web server module 100 at the server 14. The product order information may include, but is not limited to, a retail establishment identifier to identify the retail establishment selected, the one or more products selected for purchase, the price of each product, the total price, the contact information, the electronic payment information, and/or the order processing time. At operation 136, a response to the product order may be received from the retail establishment and/or the server 14. The response may be received at the communication application 60 that may be, for example, a web browser or an e-mail application. The response may be, but is not limited to, an instant message, an e-mail message, a short message, a multimedia message, an HTML message, and a CHAT message.

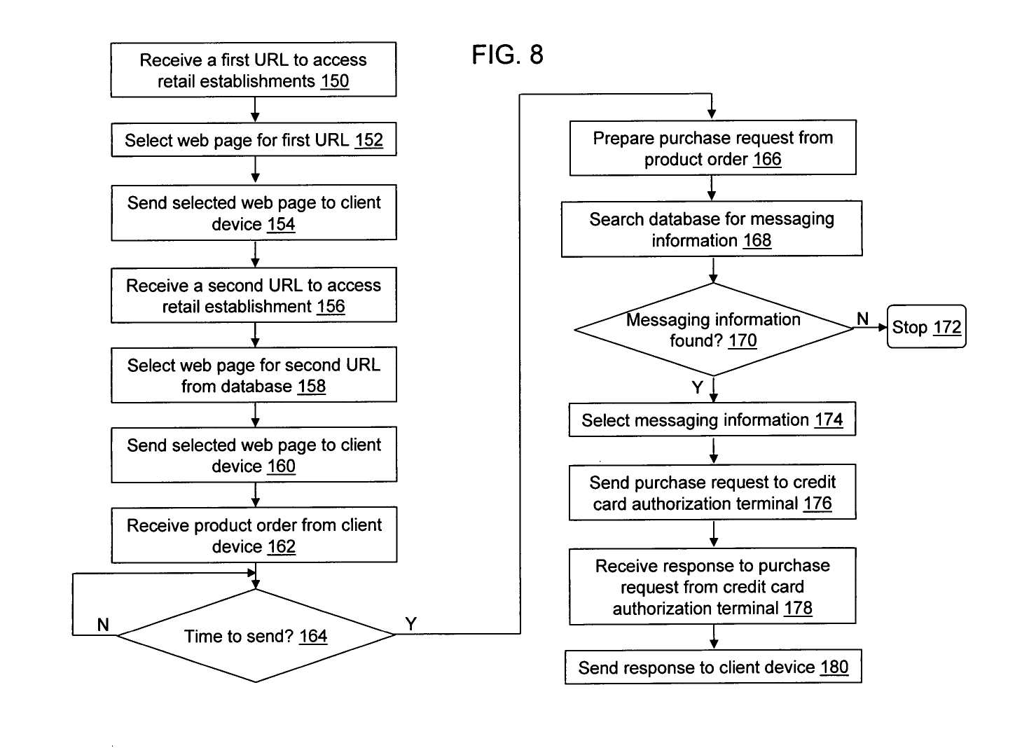

With reference to the exemplary embodiment of FIG. 8, the operations of the server 14 will be described below. FIG. 8 shows a functional flow diagram of processing operations performed at the server 14. Additional, fewer, or different operations may be performed, depending on the embodiment without deviating from the spirit of the invention. At operation 150, the web server module 100 may receive a first URL from the client device 12. The resource identified by the first URL may provide access to retail establishments as known to those skilled in the art. At operation 152, the web server module 100 selects the web page identified by the first URL. At operation 154, the web server module 100 sends the selected web page to the client device 12. As known to those skilled in the art, the web page defined by the resource in the URL may be stored in a file system on the server 14 that includes the web server module 100. The file system may be located on the same or a different device as the web server module 100.

At operation 156, the web server module 100 may receive a second URL from the client device 12. The resource identified by the second URL may provide access to an identified retail establishment of interest to the user at the client device 12 as known to those skilled in the art. At operation 158, the web server module 100 selects the web page identified by the second URL. At operation 160, the web server module 100 sends the selected web page to the client device 12. As known to those skilled in the art, the web page defined by the resource in the URL may be stored in a file system on the server 14 that includes the web server module 100. The file system may be located on the same or a different device as the web server module 100.

At operation 162, the web server module 100 receives the product order from the client device 12. The decision at operation 164 determines if the user at the client device 12 selected the order processing time. If the user selected the order processing time, the decision at operation 164 determines if the current time is equal to or greater than the order processing time selected by the user to send the product order. If the decision at operation 164 is “No,” processing stops until the order processing time is reached. If the decision at operation 164 is “Yes,” processing continues at operation 166.

At operation 166, the web server module 100 prepares a purchase request from the product order information received from the client device. In an exemplary embodiment, the web server module 100 formats the purchase request from the product order information into a message sent to the message server module 102. In an exemplary embodiment, the message is an e-mail message. The message server module 102 receives the purchase request message. The message server module 102 requests that the MMM 104 identify the messaging information for sending the purchase request to the CCAT 16 at the selected retail establishment. At operation 168, the MMM 104 searches the database 24 for the messaging information using the retail establishment identifier included in the purchase request. The decision at operation 170 determines if the messaging information of the retail establishment is found. If the messaging information is not found, processing stops at operation 172. In an exemplary embodiment, the MMM 104 may send an error message to the message server module 102 indicating that no messaging information was found for the retail establishment. The message server module 102 may send the error message to the web server module 100. The web server module 100 may send the error message to the client device 12.

If the messaging information is found, the messaging information is selected at operation 174. The messaging information may include, but is not limited to, a phone number and/or an IP address for the selected retail establishment. Searching the database may use the retail establishment identifier to locate the appropriate messaging information. A retail establishment may have messaging information for one or more CCAT 16. For example, a retail establishment may have multiple phone lines connected to multiple CCATs. At operation 176, the purchase request is sent to the CCAT 16 using the messaging information and the network 108. At operation 178, a response may be received from the CCAT 16 concerning the purchase request. In an exemplary embodiment, the response is received at the MMM 106 of the server 14. If a busy signal is received from the CCAT 16 and there is messaging information for a plurality of CCATs, the next messaging information may be used to send the purchase request.

At operation 180, the response is sent to the client device 12 from the server 14. The response may be sent to the client device 12 using a number of different transmission paths and messaging protocols. For example, the response may be sent from the MMM 106 to the message server module 104 or the response may be received directly by the message server module 104. The response may be forwarded from the message server module 104 to the web server module 100. The response may be forwarded from the web server module 100 to the client device 12. The response may be an instant message, an e-mail message, a short message, a multimedia message, an HTML message, and/or a CHAT message. The messaging protocol may change during the transmission process. For example, the response may be received as a short message by the message server module 104 that sends the response in an e-mail message to the web server module 100. The web server module 100 may reformat the response information to an HTML message that is sent to the client device 12 and displayed in the communication application 60 at the client device 12.

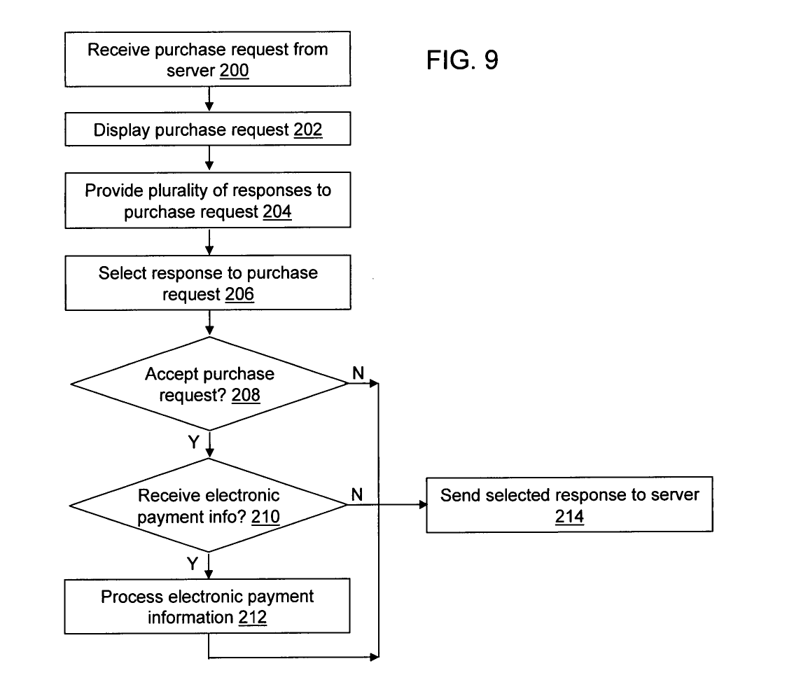

With reference to the exemplary embodiment of FIG. 9, the operations of the CCAT 16 will be described below. FIG. 9 shows a functional flow diagram of processing operations performed at the CCAT 16. Additional, fewer, or different operations may be performed, depending on the embodiment without deviating from the spirit of the invention. At operation 200, the CCAT 16 receives the purchase request from the server 14. At operation 202, the purchase request is displayed at the CCAT 16 using the terminal application 80. Displaying the purchase request at the CCAT 16 may be using the display 70. In an exemplary embodiment, the display 70 may be a printer. At operation 204, the terminal application 80 may provide a plurality of responses to the purchase request for selection by the user of the CCAT 16. For example, the plurality of responses may be:

Purchase Request Accepted—Ready in 10 Minutes;

Purchase Request Accepted—Ready in 20 Minutes;

Purchase Request Accepted—Ready in 30 Minutes;

Purchase Request Accepted—Ready in 60 Minutes;

Purchase Request Rejected—Please phone the retail establishment.

At operation 206, the user of the CCAT 16 may select a response to the purchase request from the provided plurality of responses using the input interface 74. The response may be selected, as known to those skilled in the art, using various alternatives. For example, the user may select “Purchase Request Accepted—Ready in 30 Minutes” by entering the number 3 in a keypad of the input interface 74, by using an arrow button to navigate to the selection and then selecting a button such as “OK” or “Enter,” or by touching the item on the display 70 using a touch screen input interface 74. Alternatively, the user may enter a different response at the CCAT 16 through the input interface 74 by typing in a text box window created for this purpose by the terminal application 80.

The decision at operation 208 determines if the purchase request is accepted. If the purchase request is accepted at operation 208, the decision at operation 210 determines if electronic payment information is received in the purchase request. If the electronic payment information is received, at operation 212, the electronic payment information may be processed to pay for the product. At operation 214, the selected response may be sent to the server 14. In alternative embodiments, the response may be sent directly to the client device 12.

The invention just described provides for the convenient and cost effective ordering of a product from a retail establishment using a network without requiring any additional equipment at the retail establishment for processing the product purchase requests from the network. It is understood that the invention is not confined to the particular embodiments set forth herein as illustrative, but embraces all such modifications, combinations, and permutations as come within the scope of the following claims. The functionality described may be implemented in a single executable or application or may be distributed among modules or managers that differ in number and distribution of functionality from those described herein without deviating from the spirit of the invention. Additionally, the order of execution of the functions may be changed without deviating from the spirit of the invention. Thus, the description of the exemplary embodiments is for purposes of illustration and not limitation.

What is claimed is:

1. A method of ordering a product from a retail establishment using a network, the method comprising:
sending a first web page to a client device using a network, wherein the first web page is sent from a server and comprises product information of a retail establishment;
receiving a product order from the client device using the network, the product order identifying a product selected for purchase from the retail establishment; and
sending a purchase request to a credit card authorization terminal of the retail establishment using the network, the purchase request comprising the product order.

2. The method of claim 1, further comprising, before sending the first web page to the client device:
sending a second web page to the client device, wherein the second web page is received from the server and comprises a plurality of retail establishments; and
receiving a retail establishment identifier from the client device at the server using the network, the retail establishment identifier identifying the retail establishment selected from the plurality of retail establishments.

3. The method of claim 1, further comprising:
searching a database for messaging information of the credit card authorization terminal at the server;
selecting the messaging information of the credit card authorization terminal at the server; and
using the messaging information to send the purchase request from the server to the credit card authorization terminal.

4. The method of claim 1, wherein sending the purchase request from the server to the credit card authorization terminal comprises:
sending the purchase request from the server to a message server; and
sending the purchase request from the message server to the credit card authorization terminal.

5. The method of claim 4, further comprising:
searching a database for messaging information of the credit card authorization terminal at the message server;
selecting the messaging information of the credit card authorization terminal at the message server; and
using the messaging information to send the purchase request from the message server to the credit card authorization terminal.

6. The method of claim 1, wherein using the network comprises using messaging protocols.

7. The method of claim 1, wherein the purchase request is selected from the group consisting of an instant message, an e-mail message, a short message, a multimedia message, a Hypertext Markup Language message, and a conversational hypertext access technology message.

8. The method of claim 1, further comprising sending a request for contact information from the server to the client device using the network before sending the purchase request.

9. The method of claim 8, wherein the contact information is selected from the group consisting of an instant message address, an e-mail address, a short message address, a multimedia message address, a conversational hypertext access technology address, a telephone number, and a street address.

10. The method of claim 1, further comprising:
receiving electronic payment information from the client device at the server using the network; and
sending the electronic payment information from the server to the credit card authorization terminal of the retail establishment using the network.

11. The method of claim 1, further comprising receiving an order processing time from the client device at the server using the network, wherein sending the purchase request from the server to the credit card authorization terminal occurs when a current time is greater than or equal to the order processing time.

12. A method of processing a product order at a retail establishment using a network, the method comprising:
receiving a purchase request from a server at a credit card authorization terminal using a network, the purchase request comprising a product order received from a client device; and
presenting the purchase request at the credit card authorization terminal.

13. The method of claim 12, further comprising:
providing a plurality of responses to the purchase request at the credit card authorization terminal; and
sending a response selected from the plurality of responses from the credit card authorization terminal to the client device.

14. The method of claim 13, wherein sending the response selected from the plurality of responses from the credit card authorization terminal to the client device comprises:
sending the response from the credit card authorization terminal to the server; and
sending the response from the server to the client device.

15. The method of claim 13, wherein sending the response selected from the plurality of responses from the credit card authorization terminal to the client device comprises:
sending the response from the credit card authorization terminal to a message server;
sending the response from the message server to the server; and
sending the response from the server to the client device.

16. The method of claim 12, wherein the response is selected from the group consisting of an instant message, an e-mail message, a short message, a multimedia message, a Hypertext Markup Language message, and a conversational hypertext access technology message.

17. The method of claim 12, further comprising:
receiving electronic payment information from the server at the credit card authorization terminal using the network; and
processing the electronic payment information at the credit card authorization terminal.

18. The method of claim 12, wherein presenting the purchase request at the credit card authorization terminal comprises printing the purchase request at the credit card authorization terminal.

19. A computer program product for allowing a user to place an order for a product from a retail establishment using a network, the computer program product comprising: computer code configured to:
send a first web page to a client device using a network, wherein the first web page comprises product information of a retail establishment for display at the client device;
receive a product order from the client device using the network, the product order identifying a product selected for purchase from the retail establishment; and
send a purchase request to a credit card authorization terminal of the retail establishment using the network, the purchase request displayed at the credit card authorization terminal and comprising the product order.

20. A server for providing a user with the capability to place an order for a product from a retail establishment using a network, the server comprising:
a communication interface, the communication interface configured to:
send a first web page to a client device;
receive a product order from the client device; and
send a purchase request to a credit card authorization terminal of the retail establishment;
a server application, the server application comprising computer code configured to:
select the first web page sent to the client device, wherein the first web page comprises product information of a retail establishment selected for display at the client device;
process the product order received from the client device, the product order identifying a product selected for purchase from the retail establishment; and
prepare the purchase request sent to the credit card authorization terminal, the purchase request displayed at the credit card authorization terminal and comprising the product order;
a memory, the memory configured to store the server application; and
a processor, the processor coupled to the memory and configured to execute the server application.

21. A system for providing a user with the capability to place an order for a product from a retail establishment using a network, the system comprising:
a client device, the client device comprising:
a client device communication interface, the client device communication interface configured to:
receive a first web page from a server; and
send a product order to the server;
a communication application, the communication application comprising computer code configured to:
display the first web page, wherein the first web page comprises product information of a retail establishment selected for display; and
accept the product order, the product order identifying a product selected for purchase from the retail establishment;
a client device memory, the client device memory configured to store the communication application; and
a client device processor, the client device processor coupled to the client device memory and configured to execute the communication application;
the server comprising:
a server communication interface, the server communication interface configured to:
send the first web page to the client device;
receive the product order from the client device; and
send a purchase request to a credit card authorization terminal of the retail establishment;
a server application, the server application comprising computer code configured to:
select the first web page sent to the client device;
process the product order received from the client device; and
prepare the purchase request sent to the credit card authorization terminal, the purchase request comprising the product order;
a server memory, the server memory configured to store the server application; and
a server processor, the server processor coupled to the server memory and configured to execute the server application;
a credit card authorization terminal, the credit card authorization terminal comprising:
a terminal communication interface, the terminal communication interface configured to receive the purchase request;
a terminal application, the terminal application comprising computer code configured to display the purchase request;
a terminal memory, the terminal memory configured to store the terminal application; and
a terminal processor, the terminal processor coupled to the terminal memory and configured to execute the terminal application; and
the network, wherein the network is configured to provide communication between the client device, the server, and the credit card authorization terminal.
